(19) United States
(12) Patent Application Publication
(10) Pub. No.: US 2026/0269742 A1
(43) Pub. Date: Sep. 10, 2026

(54) VOLTAGE BALANCING CIRCUITS WITH INTEGRATED BRAKING CHOPPER FOR SERIES CONNECTED INVERTERS

(71) Applicant: ABB Schweiz AG, Baden (CH)

(72) Inventor: Slavko Mocevic, Raleigh, NC (US)

(21) Appl. No.: 19/550,515

(22) Filed: Feb. 26, 2026

Related U.S. Application Data
(63) Continuation of application No. PCT/US2023/034826, filed on Oct. 10, 2023.

(51) Int. Cl. H02M 7/483; H02M 1/00; H02M 1/32; H02M 7/48; H02M 7/537

(52) U.S. Cl. CPC H02M 7/4833; H02M 1/0067; H02M 1/32; H02M 7/537; H02M 7/4815

(57) ABSTRACT

A circuit includes first, second, third, and fourth power switches in series to form a first branch in parallel with a second branch comprising first and second capacitors in series with a first node therebetween. A first brake resistor is in series with a first chopper switch to form a third branch, and a second brake resistor is in series with a second chopper switch to form a fourth branch. The third branch is between a terminal of the first capacitor and a second node between the first and second power switches. The second and third power switches have a third node therebetween. The fourth branch is between a terminal of the second capacitor and a fourth node between the third and fourth power switches. A third capacitor and/or an inductor forms a fifth branch between (i) the second and fourth node, or (ii) the first and third node.

### BACKGROUND

The field of the disclosure relates to AC motor drives, and in particular, to series connected inverters that supply multiphase AC motors.

When series connected inverters (SCIs) supply multiphase AC motors, one of the requirements is the voltage balancing of the direct current (DC) link capacitors. Because the DC link voltage balancing depends on the active power distribution between the inverter/winding sets, balancing methods are often used. In cases where the balancing methods utilize control modifications at the SCIs that introduce unacceptable complexity, voltage balancing circuits are used. Some examples of voltage balancing circuits include soft switching resonant inductor capacitor based (LC-based) circuits, switch capacitor based (C-based) circuits, and inductor based (L-based) circuits.

Further, because motor drives having a diode rectifier can potentially enter regeneration mode, a braking chopper is often utilized. The use of a braking chopper in addition to voltage balancing circuits for SCIs adds additional complexity and components for driving multiphase AC motors, adding cost and reducing reliability.

Thus, it is desirable to improve the reliability and reduce the complexity of SCIs for driving multiphase AC motors.

### BRIEF DESCRIPTION

In one aspect, an integrated voltage balancing and breaking chopper circuit is provided. The circuit includes first, second, third, and fourth power switches coupled in series to form a first branch, where the first branch is in parallel with a second branch comprising first and second capacitors coupled in series, and wherein the first and second capacitors have a first node disposed therebetween. The circuit further includes a first brake resistor coupled in series with a first chopper switch to form a third branch, where the third branch is coupled between a terminal of the first capacitor and a second node disposed between the first and second power switches, and where the second and third power switches have a third node disposed therebetween. The circuit further includes a second brake resistor coupled in series with a second chopper switch to form a fourth branch, where the fourth branch is coupled between a terminal of the second capacitor and a fourth node disposed between the third and fourth power switches. The circuit further includes and a third capacitor and/or an inductor forming a fifth branch, where the fifth branch is coupled between (i) the second node and the fourth node, or (ii) the first node and the third node.

In another aspect, a drive system for an AC multiphase machine is provided. The drive system includes a first inverter comprising a first capacitor, a second inverter comprising a second capacitor, where the first and second capacitors are coupled in series to form a first branch, and where the first and second capacitors have a first node disposed therebetween. The drive system further includes an integrated voltage balancing and breaking chopper circuit. The circuit includes first, second, third, and fourth power switches coupled in series to form a second branch, where the second branch is in parallel with the first branch. The circuit further includes a first brake resistor coupled in series with a first chopper switch to form a third branch, where the third branch is coupled between a terminal of the first capacitor and a second node disposed between the first and second power switches, and where the third and fourth power switches have a third node disposed therebetween. The circuit further includes a second brake resistor coupled in series with a second chopper switch to form a fourth branch, where the fourth branch is coupled between a terminal of the second capacitor and a fourth node disposed between the third and fourth power switches. The circuit further includes a third capacitor and/or an inductor forming a fifth branch, where the fifth branch is coupled between (i) the second node and the fourth node, or (ii) the first node and the third node.

In another aspect, an integrated voltage balancing and breaking chopper circuit is provided. The circuit includes a first power switch coupled between a positive terminal of a first capacitor and a first node, a second power switch coupled between the first node and a second node, a third power switch coupled between the second node and a third node, and a fourth power switch coupled between the third node and a negative terminal of a second capacitor, where the first and second capacitors are coupled in series. The circuit further includes a first breaking chopper coupled between the first node and one of the positive terminal of the first capacitor and a negative terminal of the first capacitor, a second breaking chopper coupled between the third node and one of a positive terminal of the second capacitor and the negative terminal of the second capacitor. The circuit further includes a third capacitor and/or an inductor coupled between (i) the first node and the third node, or (ii) the second node and a fourth node at a connection between the negative terminal of the first capacitor and the positive terminal of the second capacitor.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIG. 1 depicts a motor drive as known in the art.

FIG. 2A depicts a discrete LC-based voltage balancing (VB) and braking chopper (BC) circuit as known in the art.

FIG. 2B depicts an integrated LC-based VB-BC circuit in an exemplary embodiment.

FIG. 3 depicts a block diagram of a controller in an exemplary embodiment.

FIG. 4A depicts graphs that illustrate various electrical and operating states of the integrated LC-based VB-BC of FIG. 2B as a motor enters into and out of generation mode in an exemplary embodiment.

FIG. 4B depicts graphs that illustrate various electrical and operating states of the integrated LC-based VB-BC of FIG. 2B operating in BC mode in an exemplary embodiment.

FIG. 4C depicts graphs that illustrate various electrical and operating states of the integrated LC-based VB-BC of FIG. 2B operating in VB mode in an exemplary embodiment.

FIG. 5A depicts a discrete C-based VB and BC circuit as known in the art.

FIG. 5B depicts an integrated C-based VB-BC circuit in an exemplary embodiment.

FIG. 6A depicts graphs that illustrate various electrical and operating states of the integrated C-based VB-BC of FIG. 5B as a motor enters into and out of generation mode in an exemplary embodiment.

FIG. 6B depicts graphs that illustrate various electrical and operating states of the integrated C-based VB-BC of FIG. 5B operating in BC mode in an exemplary embodiment.

FIG. 6C depicts graphs that illustrate various electrical and operating states of the integrated C-based VB-BC of FIG. 5B operating in VB mode in an exemplary embodiment.

FIG. 7A depicts a discrete L-based VB and BC circuit as known in the art.

FIG. 7B depicts an integrated L-based VB-BC circuit in an exemplary embodiment.

FIG. 8A depicts graphs that illustrate various electrical and operating states of the integrated L-based VB-BC of FIG. 7B as a motor enters into and out of generation mode in an exemplary embodiment.

FIG. 8B depicts graphs that illustrate various electrical and operating states of the integrated L-based VB-BC of FIG. 7B operating in BC mode in an exemplary embodiment.

FIG. 8C depicts graphs that illustrate various electrical and operating states of the integrated L-based VB-BC of FIG. 7B operating in VB mode in an exemplary embodiment.

FIGS. 9A, 9B, 9C, 9D, and 9E depict various expansion circuit topologies for the integrated LC, C, and L based VB-BC circuits of FIGS. 2B, 5B, and 7B in exemplary embodiments.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

As discussed previously, one concern of SCIs that supply multiphase AC motors is unacceptably high voltage imbalances of the DC link capacitors. During operation, the DC voltage balance mainly depends on the active power distribution between the inverter/winding sets. Typically, the voltage imbalances at the DC link capacitors is mitigated using independent control of the SCIs, as independent control of the SCIs allows direct control of the active power, which in turn may be used to achieve DC voltage balance at the DC-link capacitors.

However, in situations where controlling the SCIs to achieve DC voltage balance introduces unacceptable control complexity and/or SCI operation and/or motor drive performance, specific voltage balancing circuits may be used as previously described, such as LC-based, C-based, and L-based voltage balancing circuits. In addition, braking choppers are also used when motor drives having diode rectifiers in certain applications can potentially enter generation mode. For example, during deceleration, a motor can act as a generator and feed energy back to the converter, and thus, charge the DC link capacitors. This is typically the case where the motor is controlling a high inertia load in applications such as trains, cranes, elevators, centrifuges, large fans, etc. Because this energy cannot be transmitted back to the grid via the diode front end rectifier, the motor drive DC bus voltages will increase. To prevent the DC link voltage from reaching unacceptable levels for both the passive and active components in the DC link voltage circuits, mechanisms for dissipating the energy generated by the motor during generation mode are required. A brake resistor is an element that is connected to a braking chopper, and it is designed to convert the excess energy generated by the motor during generation mode into thermal energy that can be dissipated as heat. Typically, braking choppers and/or the control systems that operate the braking choppers, monitor the DC link voltages, and when the DC link voltages reach a threshold level, the braking chopper switches the brake resistor into the DC link circuit to maintain the DC link voltages at an acceptable level. When generation mode ends and the motor is no longer supplying energy to the DC link circuits, the braking chopper is disengaged.

In applications that utilize braking chopper circuits and voltage balancing circuits, a large number of semiconductor devices and passive components are typically needed, which increases the cost and reduces the reliability of the motor drive.

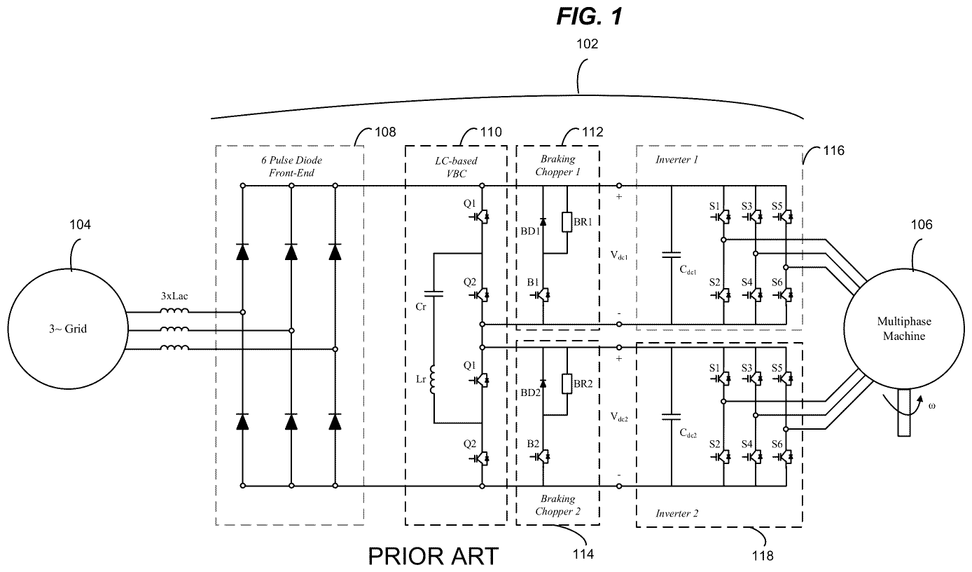

FIG. 1 depicts a motor drive 102 as known in the art. Motor drive 102 receives three phase AC power from an electric grid 104 and selectively supplies three phase AC power to a multiphase machine 106. Motor drive 102 includes a diode front end 108 forming a rectifier, an LC based voltage balancing circuit 110, a first braking chopper 112, a second braking chopper 114, a first inverter 116, and a second inverter 118. First inverter 116 and second inverter 118 form SCIs for multiphase machine 106.

In the motor drive 102 of FIG. 1, a minimum of six additional power switches and two diodes are needed to ensure the operation of motor drive 102 due to multiphase machine 106 entering and exiting generation mode, regardless of the topology of the voltage balancing circuit used.

In the embodiments described herein, integrated voltage balancing (VB) circuits and braking chopper (BC) circuits are described that combine what is typically separate VB and BC circuits into a single circuit in order to reduce the number of semiconductor devices that are not part of the SCIs. This reduces the cost and increases the reliability of the solution as compared to the two circuit implementations typically used for voltage balancing and braking chopper circuits. In the embodiments described herein, various topologies will be discussed including LC-based, C-based, and L-based integrated VB and BC circuits.

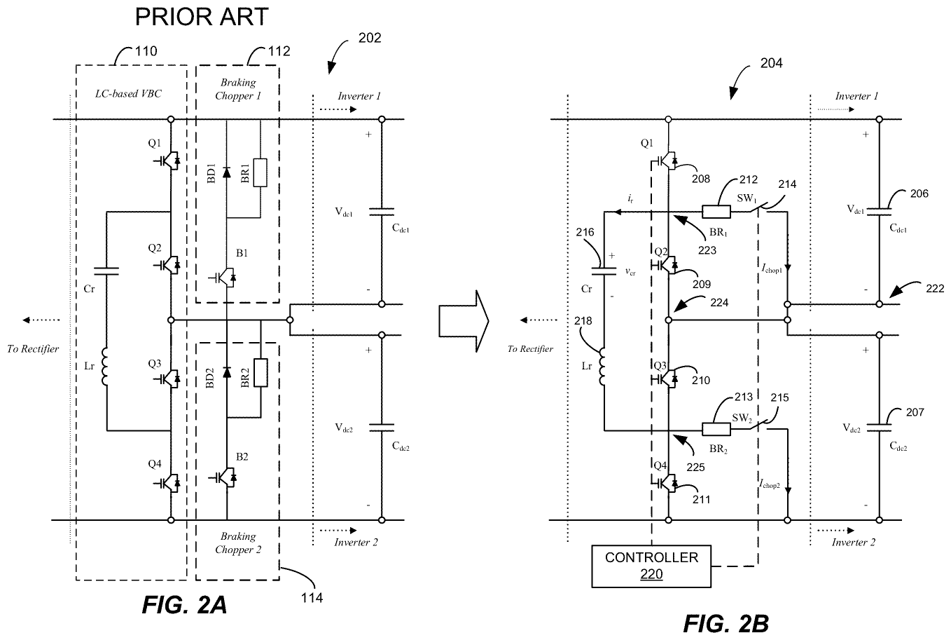

FIG. 2A depicts a discrete LC-based VB-BC circuit 202 as known in the art. FIG. 2B depicts an integrated LC-based VB-BC circuit 204 in an exemplary embodiment. In this embodiment, integrated LC-based VB-BC circuit 204 is configured to electrically couple with capacitors 206 and 207 arranged in series. Capacitor 206 may, for example, comprise a capacitor for a first inverter, and capacitor 207 may, for example, comprise a capacitor for a second inverter. The first and second inverters may comprise SCIs for controlling a multiphase machine, such as multiphase machine 106.

In this embodiment, integrated LC-based VB-BC circuit 204 comprises power switches 208 (Q1), 209 (Q2), 210 (Q3) and 211 (Q4) that are arranged in series. Power switches 208 (Q1), 209 (Q2), 210 (Q3) and 211 (Q4) are arranged in parallel with the series combination of capacitor 206 and capacitor 207. Integrated LC-based VB-BC circuit 204 further comprises brake resistors 212 and 213, chopper switches 214 and 215, which may comprise mechanical switches and/or semiconductor devices, and a series combination of a capacitor 216 and an inductor 218 forming a resonant LC circuit. As compared to discrete LC-based VB-BC circuit 202, integrated LC-based VB-BC circuit 204 achieves the same function but utilizes fewer diodes and power semiconductor devices, thereby reducing the cost and increasing the reliability of the solution.

Although the series combination of brake resistor 212 and chopper switch 214 are coupled to the negative terminal of capacitor 206 in this embodiment, the series combination of brake resistor 212 and chopper switch 214 may be coupled to the positive terminal of capacitor 206 in other embodiments. In a similar manner, although the series combination of brake resistor 213 and chopper switch 215 are coupled to the negative terminal of capacitor 207 in this embodiment, the series combination of brake resistor 213 and chopper switch 215 may be coupled to the positive terminal of capacitor 207 in other embodiments.

In this embodiment, integrated LC-based VB-BC circuit 204 includes a controller 220, which controls the operation of integrated LC-based VB-BC circuit 204. In particular, controller 220 controls the operation of power switches 208 (Q1), 209 (Q2), 210 (Q3), and 211 (Q4), and chopper switches 214 and 215. Controller 220 also measures various electrical parameters of integrated LC-based VB-BC circuit 204, including the voltages at capacitors 206, 207, and 216, referred to respectively as V_{dc1}, V_{dc2}, and V_{cr}, and the chopper current flowing through chopper switches 214 and 215, referred to respectively as I_{chop1} and I_{chop2}. Controller 220 may also measure the resonant current through inductor 218, referred to as iᵣ. However, controller 220 may measure any additional electrical parameter in integrated LC-based VB-BC circuit 204 in order to perform the functionality described herein for controller 220 for integrated LC-based VB-BC circuit 204.

In this embodiment, integrated LC-based VB-BC circuit 204 includes a plurality of nodes 222, 223, 224, and 225, where the electrical components of integrated LC-based VB-BC circuit 204 electrically connect with each other. In particular, node 222 is located at the electrical connection between capacitors 206 and 207, node 223 is located at the electrical connection between power switches 208 (Q1) and 209 (Q2), node 224 is located at the electrical connection between power switches 209 (Q2) and 210 (Q3), and node 225 is located at the electrical connection between power switches 210 (Q3) and 211 (Q4).

In this embodiment, the series combination of brake resistor 212 and chopper switch 214 is electrically connected between nodes 222 and 223, the series combination of brake resistor 213 and chopper switch 215 is electrically connected between node 225 and the negative terminal of capacitor 207, and the series combination of capacitor 216 and inductor 218 is electrically connected between nodes 223 and 225. In this embodiment, nodes 222 and 224 are electrically connected together.

During VB operation, controller 220 turns off (opens) chopper switches 214 and 215, and operates power switches 208 (Q1), 209 (Q2), 210 (Q3), and 211 (Q4) to implement the resonant LC circuit formed by capacitor 216 and inductor 218, and also operates power switches 208 (Q1), 209 (Q2), 210 (Q3), and 211 (Q4) to balance the voltage V_{dc1} at capacitor 206 with the voltage V_{dc2} at capacitor 207. When the motor enters generation mode, the voltage V_{dc1} at capacitor 206 and the voltage V_{dc2} at capacitor 207 may begin to increase, which is detected by controller 220. If the voltage at capacitor 206 and/or capacitor 207 increase to a magnitude that exceeds a threshold voltage, controller 220 switches integrated LC-based VB-BC circuit 204 from VB mode to BC mode, by modifying the operation of power switches 208 (Q1), 209 (Q2), 210 (Q3), and 211 (Q4) and turning chopper switch 214 and/or chopper switch 215 on (closed). During BC mode, brake resistor 212 and/or brake resistor 213 dissipate the excess energy transferred from the motor to capacitor 206 and/or capacitor 207 as heat. When controller 220 determines that generation mode has ended, controller 220 switches integrated LC-based VB-BC circuit 204 from BC mode to VB mode, by modifying the operation of power switches 208 (Q1), 209 (Q2), 210 (Q3), and 211 (Q4) and turning chopper switches 214 and 215 off (open) in order to resume balancing the voltage V_{dc1} at capacitor 206 with the voltage V_{dc2} at capacitor 207.

As discussed above, when controller 220 operates power switches 208 (Q1), 209 (Q2), 210 (Q3) and 211 (Q4) while chopper switches 214 and 215 are off (open circuit), VB mode is implemented by integrated LC-based VB-BC circuit 204. BC mode is implemented when controller 220 turns chopper switches 214 and 215 on (closed). In order to prevent the VB and BC modes from interfering with each other, controller 220 may turn on (close) chopper switches 214 and 215 during the dead time of power switches 208 (Q1), 209 (Q2), 210 (Q3) and 211 (Q4) when the current of the resonant LC circuit iᵣ is about zero amps. Due to an impedance change and a resulting phase shift when adding brake resistors 212 and 213 in integrated LC-based VB-BC circuit 204, controller 220 may turn off power switches 209 (Q2) and 211 (Q4) during BC mode in order to prevent the loss of soft switching. This may be performed as there may be no need to implement VB mode during BC mode, since the voltages of capacitors 206 and 207 may be clamped at the threshold voltage when controller 220 transitions integrated LC-based VB-BC circuit 204 from VB to BC mode. Upon termination of the generation mode of the motor, controller 220 turns off (opens) chopper switches 214 and 215, and controller 220 operates power switches 209 (Q2) and 211 (Q4) without causing an overshoot of the voltages at capacitors 206, 207, and 216, as their voltages V_{dc1}, V_{dc2}, and V_{cr}, respectively, may be about equal with each other.

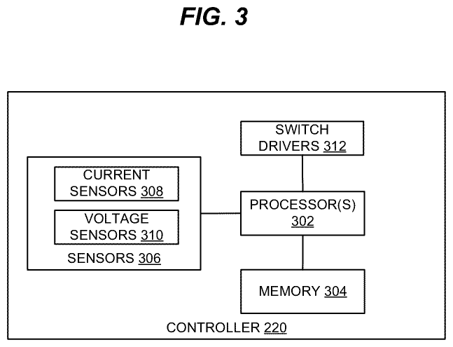

FIG. 3 depicts a block diagram of controller 220 in an exemplary embodiment. Controller 220 comprises any component, system, or device that performs the functionality described herein for controller 220. Controller 220 will be described with respect to various discrete elements, which perform functions. These elements may be combined in different embodiments or segmented into different discrete elements in other embodiments. In this embodiment, controller 220 comprises at least one processor 302, at least one memory 304, at least one sensor 306, and at least one switch driver 312.

In some embodiments, memory 304 stores programmable instructions that control the operation of processor 302 in order to implement the functionality described herein for controller 220. Sensors 306 include one or more current sensors 308 and one or more voltage sensors 310, which may be used by processor 302 to measure the voltages and currents at integrated LC-based VB-BC circuit 204, and other circuits, as described herein. For example, voltage sensors 310 may be used by processor 302 to measure the voltage V_{dc1} at capacitor 206, the voltage V_{dc2} at capacitor 207, the voltage V_{cr} at capacitor 216, etc. Current sensor 308 may be used by processor 302 to measure the current iᵣ at inductor 218, the current I_{chop1} through chopper switch 214, and the current I_{chop2} through chopper switch 215. Switch drivers 312 are controlled by processor 302 to modify the on/off (closed/open) state of power switches 208 (Q1), 209 (Q2), 210 (Q3), and 211 (Q4), and chopper switches 214 and 215.

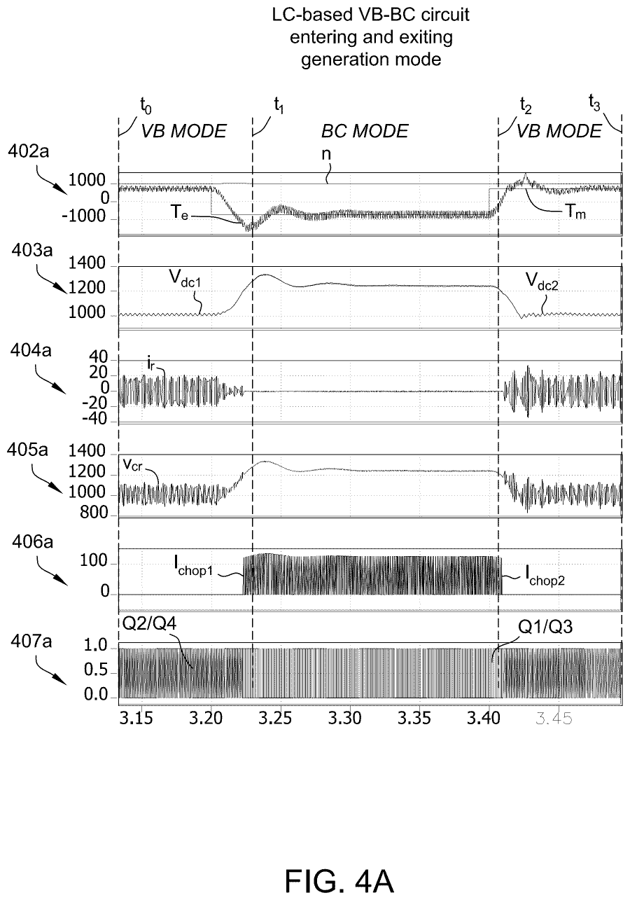

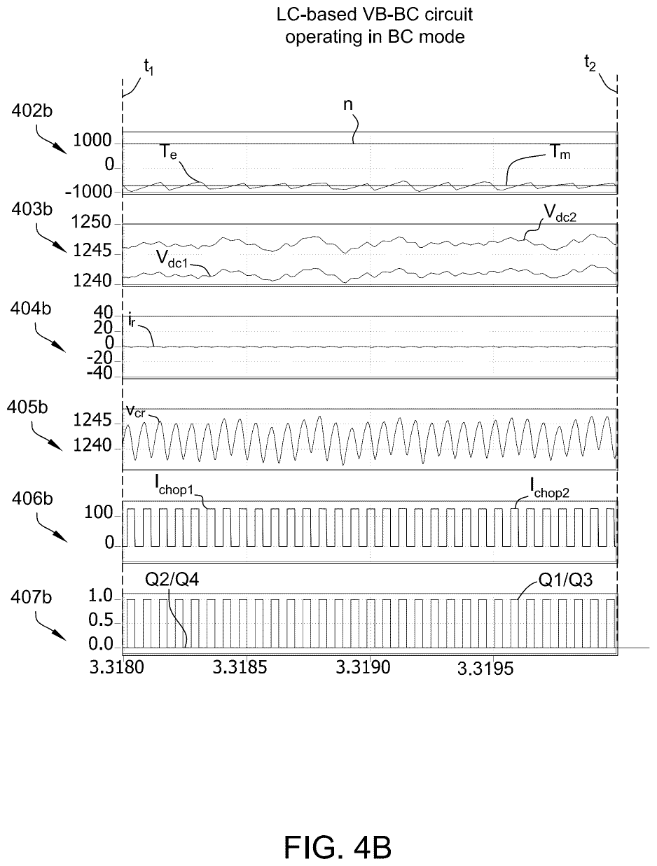

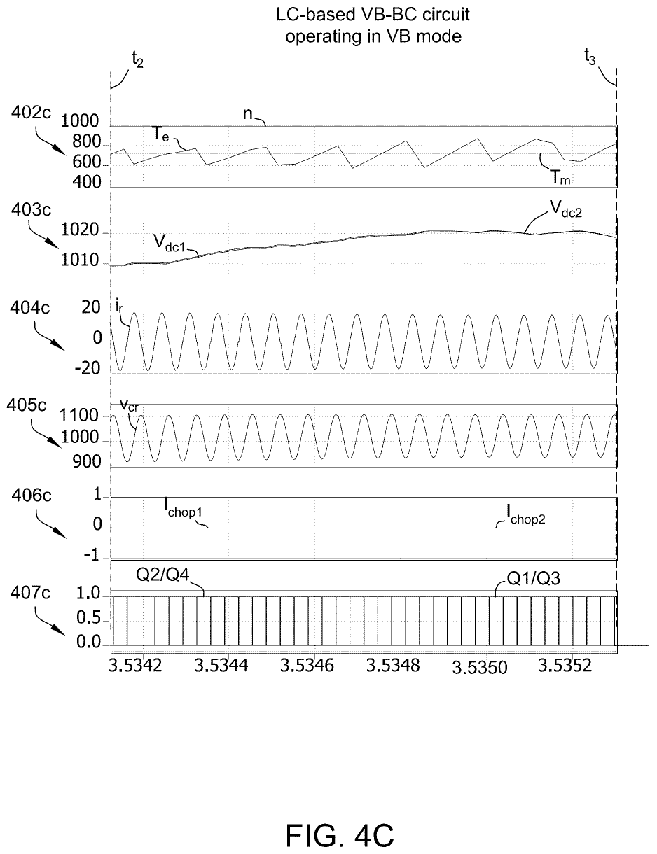

FIG. 4A depicts graphs 402a, 403a, 404a, 405a, 406a, and 407a that illustrate various electrical criteria of integrated LC-based VB-BC circuit 204 as the motor enters into and out of generation mode in an exemplary embodiment. FIG. 4B depicts graphs 402b, 403b, 404b, 405b, 406b, and 407b that illustrate various electrical criteria of integrated LC-based VB-BC circuit 204 operating in BC mode in an exemplary embodiment. FIG. 4C depicts graphs 402c, 403c, 404c, 405c, 406c, and 407c that illustrate various electrical criteria of integrated LC-based VB-BC circuit 204 operating in VB mode in an exemplary embodiment.

In particular, integrated LC-based VB-BC circuit 204 operates in VB mode at time t₀ and t₃, enters into BC mode from VB mode at time t₁, and exits BC mode and returns to VB mode at time t₂.

Graphs 402a, 402b, and 402c illustrate the speed of the motor (n), the electrical torque Tₑ of the motor, and the motor loading torque Tₘ. Graphs 403a, 403b, and 403c illustrate the voltages V_{dc1} and V_{dc2} at capacitors 206 and 207. Graphs 404a, 404b, and 404c illustrate the resonant current iᵣ of inductor 218. Graphs 405a, 405b, and 405c illustrate the resonant capacitor voltage V_{cr} of capacitor 216. Graphs 406a, 406b, and 406c illustrate the chopper current I_{chop1} and I_{chop2}, and graphs 407a, 406b, and 407c illustrate the control signals of power switches 208 (Q1), 209 (Q2), 210 (Q3), and 211 (Q4). From time t₀ to t₁, integrated LC-based VB-BC circuit 204 starts by operating in VB mode, where controller 220 operates power switches 208 (Q1) and 210 (Q3) together, and operates power switches 209 (Q2) and 211 (Q4) together and complimentary to power switches 208 (Q1) and 210 (Q3) in order to balance the voltage V_{dc1} at capacitor 206 and the voltage V_{dc2} at capacitor 207. When the voltages of capacitors 206 and 207 increase to a magnitude that exceeds the threshold voltage due to the motor operating in generation mode (e.g., Tₑ is negative), controller 220 turns on (closes) chopper switches 214 and 215, power switches 209 (Q2) and 211 (Q4) are turned off, and integrated LC-based VB-BC circuit 204 operates in BC mode as depicted in FIG. 4B. The resonant current iᵣ is about zero (e.g., power switches 209 (Q2) and 211 (Q4) are not switching), and braking chopper currents I_{chop1} and I_{chop2} flowing through brake resistors 212 and 213, respectively, dissipates the energy supplied by the motor as heat. After integrated LC-based VB-BC circuit 204 transitions out of BC mode (e.g., Tₑ transitions from negative to positive at time t₂), controller 220 transitions integrated LC-based VB-BC circuit 204 from BC mode to VB mode, which is depicted in FIG. 4C. In VB mode, controller 220 operates power switches 208 (Q1) and 210 (Q3) together, and operates power switches 209 (Q2) and 211 (Q4) together and complimentary to power switches 208 (Q1) and 210 (Q3) in order to balance the voltage V_{dc1} at capacitor 206 and the voltage V_{dc2} at capacitor 207 with each other.

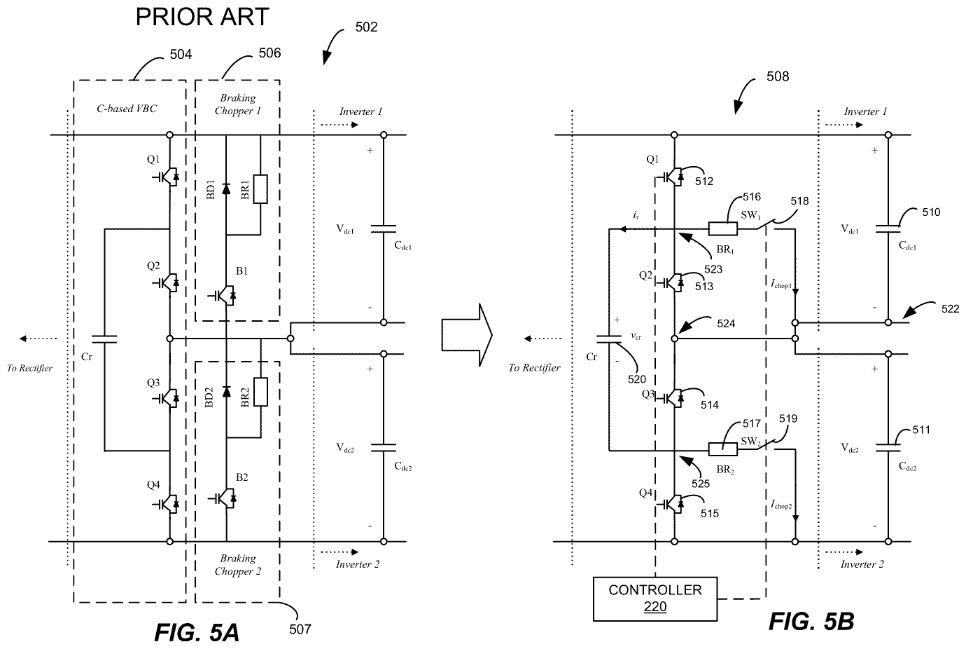

FIG. 5A depicts a discrete C-based VB-BC circuit 502 with a separate voltage balancing circuit 504 and braking chopper circuits 506 and 507 as known in the art. FIG. 5B depicts an integrated C-based VB-BC circuit 508 in an exemplary embodiment. In this embodiment, integrated C-based VB-BC circuit 508 is configured to electrically couple with capacitors 510 and 511 arranged in series. Capacitor 510 may, for example, comprise a capacitor for a first inverter, and capacitor 511 may, for example, comprise a capacitor for a second inverter. The first and second inverters may comprise SCIs for controlling a multiphase machine, such as multiphase machine 106.

In this embodiment, integrated C-based VB-BC circuit 508 comprises power switches 512 (Q1), 513 (Q2), 514 (Q3) and 515 (Q4), brake resistors 516 and 517, chopper switches 518 and 519, which may comprise mechanical switches and/or semiconductor devices, and a capacitor 520 forming part of a switched capacitor circuit. As compared to discrete C-based VB-BC circuit 502, integrated C-based VB-BC circuit 508 achieves the same function but utilizes fewer diodes and power semiconductor devices, thereby reducing the cost and increasing the reliability of the solution.

Although the series combination of brake resistor 516 and chopper switch 518 are coupled to the negative terminal of capacitor 510 in this embodiment, the series combination of brake resistor 516 and chopper switch 518 may be coupled to the positive terminal of capacitor 510 in other embodiments. In a similar manner, although the series combination of brake resistor 517 and chopper switch 519 are coupled to the negative terminal of capacitor 511 in this embodiment, the series combination of brake resistor 517 and chopper switch 519 may be coupled to the positive terminal of capacitor 511 in other embodiments.

In this embodiment, controller 220 controls the operation of power switches 512 (Q1), 513 (Q2), 514 (Q3), and 515 (Q4), and chopper switches 518 and 519 (e.g., via switch drivers 312, see FIG. 3). Controller 220 also measures various electrical parameters of integrated C-based VB-BC circuit 508 utilizing sensors 306, including the voltages at capacitors 510, 511, and 520, referred to respectively as V_{dc1}, V_{dc2}, and V_{cr} using voltage sensors 310. Further, controller 220 measures the chopper current flowing through chopper switches 518 and 519, referred to respectively as I_{chop1} and I_{chop2}, using current sensors 308. Controller 220 may also measure the current through capacitor 520, referred to as iᵣ, using current sensors 308. However, controller 220 may measure any additional electrical parameter in integrated C-based VB-BC circuit 508 in order to perform the functionality described herein for controller 220 for integrated C-based VB-BC circuit 508.

In this embodiment, integrated C-based VB-BC circuit 508 includes a plurality of nodes 522, 523, 524, and 525, where the electrical components of integrated C-based VB-BC circuit 508 electrically connect with each other. In particular, node 522 is located at the electrical connection between capacitors 510 and 511, node 523 is located at the electrical connection between power switches 512 (Q1) and 513 (Q2), node 524 is located at the electrical connection between power switches 513 (Q2) and 514 (Q3), and node 525 is located at the electrical connection between power switches 514 (Q3) and 515 (Q4).

In this embodiment, the series combination of brake resistor 516 and chopper switch 518 is electrically connected between nodes 522 and 523, the series combination of brake resistor 517 and chopper switch 519 is electrically connected between node 525 and the negative terminal of capacitor 511, and capacitor 520 is electrically connected between nodes 523 and 525. In this embodiment, nodes 522 and 524 are electrically connected.

During VB operation, controller 220 turns off (opens) chopper switches 518 and 519, and operates power switches 512 (Q1), 513 (Q2), 514 (Q3), and 515 (Q4) to implement a switch capacitor circuit that includes capacitor 520, and also operates power switches 512 (Q1), 513 (Q2), 514 (Q3), and 515 (Q4) to balance the voltage V_{dc1} at capacitor 510 with the voltage V_{dc2} at capacitor 511. When the motor enters generation mode, the voltages at capacitors 510 and 511 may begin to increase, which is detected by controller 220 using voltage sensors 310. If the voltages at capacitor 510 and/or capacitor 511 increase to a magnitude that exceeds a threshold voltage, controller 220 switches integrated C-based VB-BC circuit 508 from VB mode to BC mode, by modifying the operation of power switches 512 (Q1), 513 (Q2), 514 (Q3), and 515 (Q4) and turning chopper switch 518 and/or chopper switch 519 on (closed). During BC mode, brake resistors 516 and 517 dissipate the excess energy transferred from the motor to integrated C-based VB-BC circuit 508 as heat. When controller 220 determines that generation mode has ended, controller 220 switches integrated C-based VB-BC circuit 508 from BC mode to VB mode, by modifying the operation of power switches 512 (Q1), 513 (Q2), 514 (Q3), and 515 (Q4) and turning chopper switches 518 and 519 off (open).

As discussed above, when controller 220 operates power switches 512 (Q1), 513 (Q2), 514 (Q3), and 515 (Q4) while chopper switches 518 and 519 are off (open circuit), VB operation is implemented by integrated C-based VB-BC circuit 508. BC operation is implemented when controller 220 turns chopper switches 518 and 519 on (closed). In order to prevent the VB and BC operations from interfering with each other, controller 220 may turn on (close) chopper switches 518 and 519 during the dead time of power switches 512 (Q1), 513 (Q2), 514 (Q3), and 515 (Q4) when the current iᵣ of the capacitor 520 is about zero amps. Because adding brake resistors 516 and 517 in integrated C-based VB-BC circuit 508 does not modify the operation of the circuit, controller 220 may continue to operate power switches 513 (Q2) and 515 (Q4) during BC operation. However, in some embodiments, power switches 513 (Q2) and 515 (Q4) may also be turned off in BC mode.

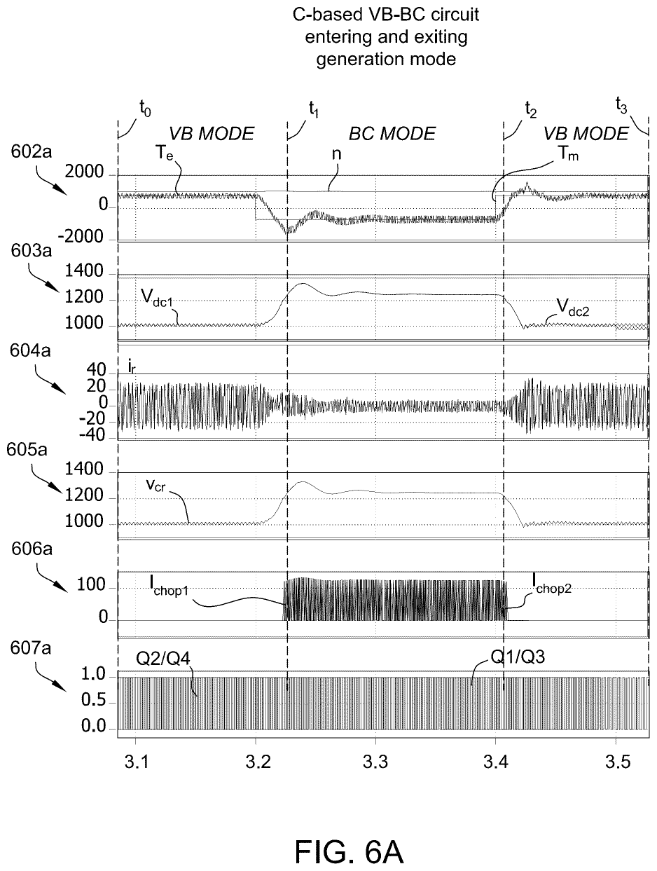

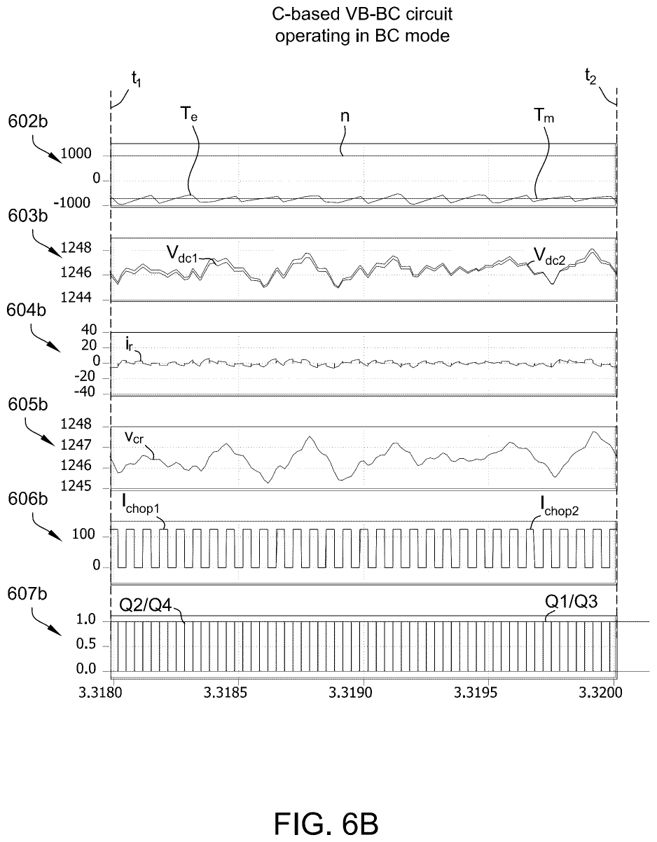

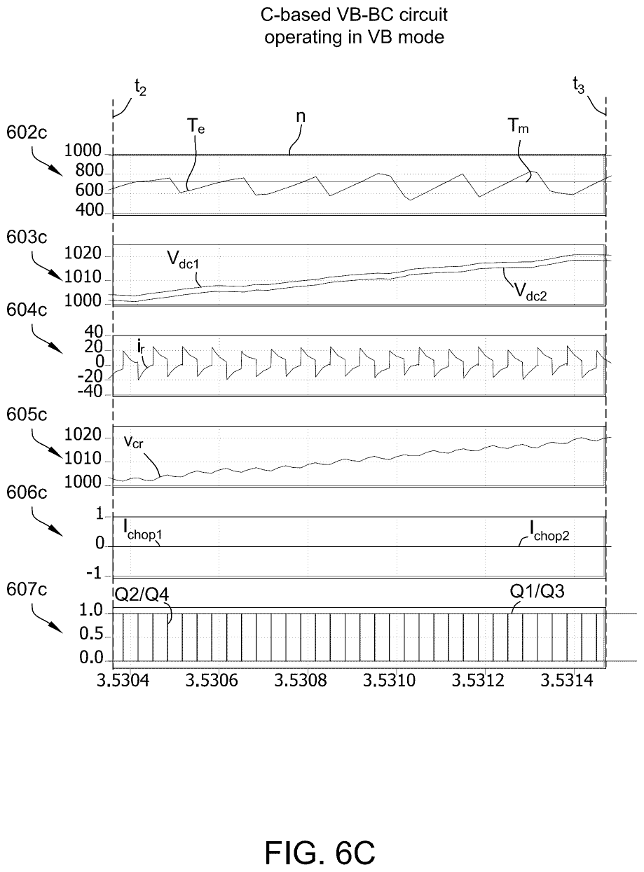

FIG. 6A depicts graphs 602a, 603a, 604a, 605a, 606a, and 607a that illustrate various electrical and operating states of integrated C-based VB-BC circuit 508 as the motor enters into and out of generation mode in an exemplary embodiment. FIG. 6B depicts graphs 602b, 603b, 604b, 605b, 606b, and 607b that illustrate various electrical and operating states of integrated C-based VB-BC circuit 508 operating in BC mode in an exemplary embodiment. FIG. 6C depicts graphs 602c, 603c, 604c, 605c, 606c, and 607c that illustrate various electrical and operating states of integrated C-based VB-BC circuit 508 operating in VB mode in an exemplary embodiment.

In particular, integrated C-based VB-BC circuit 508 operates in VB mode at time t₀ and t₃, enters into BC mode from VB at time t₁, and exits BC mode and returns to VB mode at time t₂.

Graphs 602a, 602b, and 602c illustrate the speed of the motor (n), the electrical torque Tₑ of the motor, and the motor loading torque Tₘ. Graphs 603a, 603b, and 603c illustrate the voltage V_{dc1} at capacitors 510 and the voltage V_{dc2} at capacitor 511. Graphs 604a, 604b, and 604c illustrate the current iᵣ of capacitor 520. Graphs 605a, 605b, and 605c illustrate the capacitor voltage V_{cr} of capacitor 520. Graphs 606a, 606b, 606c illustrate the chopper current I_{chop1} and I_{chop2}, and graphs 607a, 607b, and 607c illustrate the control signals of power switches 512 (Q1), 513 (Q2), 514 (Q3), and 515 (Q4). From time t₀ to t₁, integrated C-based VB-BC circuit 508 starts by operating in VB mode, where controller 220 operates power switches 512 (Q1) and 514 (Q3) together and power switches 513 (Q2) and 515 (Q4) together and complimentary to power switches 512 (Q1) and 514 (Q3), in order to balance the voltage V_{dc1} at capacitors 510 and the voltage V_{dc2} at capacitor 511 with each other. When the voltages of capacitors 510 and 511 increase to a magnitude that exceeds a threshold voltage due to the motor operating in generation mode (e.g., Tₑ is negative), controller 220 turns on (closes) chopper switches 518 and 519, power switches 513 (Q2) and 515 (Q4) remain in operation and switch complementary to each other, and integrated C-based VB-BC circuit 508 operates in BC mode as depicted in FIG. 6B. Braking chopper currents I_{chop1} and I_{chop2} flowing through brake resistors 516 and 517, respectively, dissipates the energy supplied by the motor as heat. After integrated C-based VB-BC circuit 508 transitions out of BC mode (e.g., Tₑ transitions from negative to positive at time t₂), controller 220 transitions integrated C-based VB-BC circuit 508 from BC mode to VB mode, which is depicted in FIG. 6C. In VB mode, controller 220 operates power switches 512 (Q1) and 514 (Q3) together and power switches 513 (Q2) and 515 (Q4) together and complimentary to power switches 512 (Q1) and 514 (Q3), in order to balance the voltage V_{dc1} at capacitors 510 and the voltage V_{dc2} at capacitor 511 with each other.

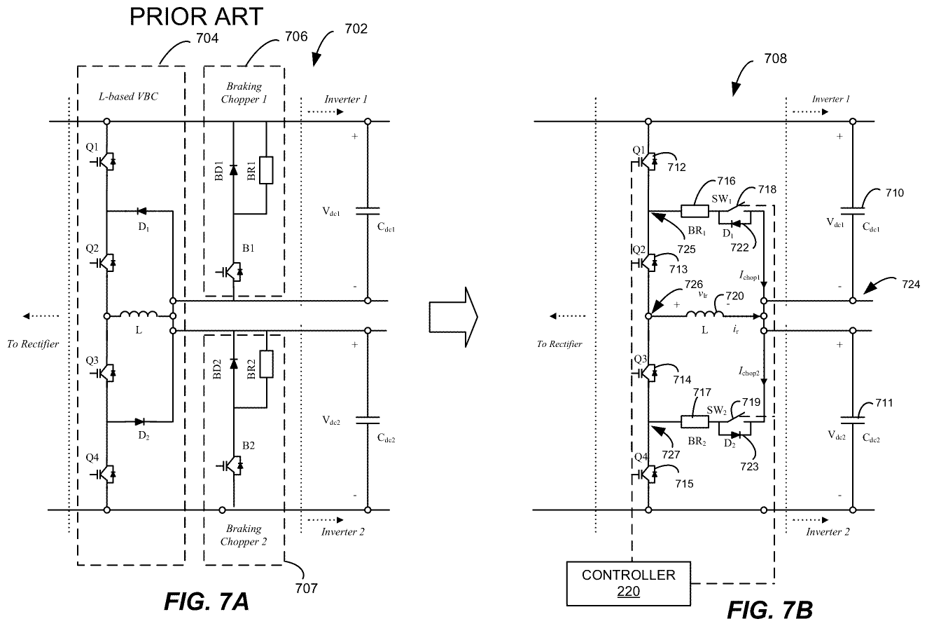

FIG. 7A depicts a discrete L-based VB-BC circuit 702 with a separate voltage balancing circuit 704 and braking chopper circuits 706 and 707 as known in the art. FIG. 7B depicts an integrated L-based VB-BC circuit 708 in an exemplary embodiment. In this embodiment, integrated L-based VB-BC circuit 708 is configured to electrically couple with capacitors 710 and 711 arranged in series. Capacitor 710 may, for example, comprise a capacitor for a first inverter, and capacitor 711 may, for example, comprise a capacitor for a second inverter. The first and second inverters may comprise SCIs for controlling a multiphase machine, such as multiphase machine 106.

In this embodiment, integrated L-based VB-BC circuit 708 comprises power switches 712 (Q1), 713 (Q2), 714 (Q3) and 715 (Q4), brake resistors 716 and 717, chopper switches 718 and 719, which may comprise mechanical switches and/or semiconductor devices, an inductor 720 forming part of a switched inductor circuit, and diodes 722 and 723. As compared to discrete L-based VB-BC circuit 702, integrated L-based VB-BC circuit 708 achieves the same function but utilizes fewer diodes and power semiconductor devices, thereby reducing the cost and increasing the reliability of the solution.

In this embodiment, controller 220 controls the operation of power switches 712 (Q1), 713 (Q2), 714 (Q3), and 715 (Q4), and chopper switches 718 and 719 (e.g., via switch drivers 312, see FIG. 3). Controller 220 also measures various electrical parameters of integrated L-based VB-BC circuit 708 utilizing sensors 306, including the voltages at capacitors 710 and 711, referred to respectively as V_{dc1} and V_{dc2}, and the voltage at inductor 720, referred to as Vₗᵣ, using voltage sensors 310. Further, controller 220 measures the chopper current flowing through chopper switches 718 and 719, referred to respectively as I_{chop1} and I_{chop2}, using current sensors 308. Controller 220 may also measure the current through inductor 720, referred to as iᵣ, using current sensors 308. However, controller 220 may measure any additional electrical parameter in integrated L-based VB-BC circuit 708 in order to perform the functionality described herein for controller 220 for integrated L-based VB-BC circuit 708.

In this embodiment, integrated L-based VB-BC circuit 708 includes a plurality of nodes 724, 725, 726, and 727, where the electrical components of integrated L-based VB-BC circuit 708 electrically connect with each other. In particular, node 724 is located at the electrical connection between capacitors 710 and 711, node 725 is located at the electrical connection between power switches 712 (Q1) and 713 (Q2), node 726 is located at the electrical connection between power switches 713 (Q2) and 714 (Q3), and node 727 is located at the electrical connection between power switches 714 (Q3) and 715 (Q4).

In this embodiment, the series combination of brake resistor 716 and chopper switch 718 is electrically connected between nodes 724 and 725, the series combination of brake resistor 717 and chopper switch 719 is electrically connected between nodes 724 and 727, and inductor 720 is electrically connected between nodes 724 and 726.

During VB operation, controller 220 turns off (opens) chopper switches 718 and 719, and operates power switches 712 (Q1), 713 (Q2), 714 (Q3), and 715 (Q4) to implement a switch inductor circuit that includes inductor 720, and also operates power switches 712 (Q1), 713 (Q2), 714 (Q3), and 715 (Q4) to balance the voltage V_{dc1} at capacitor 710 with the voltage V_{dc2} at capacitor 711. In VB mode, controller 220 operates power switches 712 (Q1) and 713 (Q2) at the same time, and operates power switches 714 (Q3) and 714 (Q4) also at the same time, but complimentary to power switches 712 (Q1) and 713 (Q2). Diodes 722 and 723 provide clamping in case of mismatches. Mismatches may occur, for example, due to the electrical properties of power switches 712 (Q1), 713 (Q2), 714 (Q3), and 715 (Q4) that result in power switches 712 (Q1), 713 (Q2), 714 (Q3), and 715 (Q4) having slightly different turn-on and turn-off times, and/or due to the electrical properties of switch drivers 312, which can result in slightly different turn-on and turn-off times for power switches 712 (Q1), 713 (Q2), 714 (Q3), and 715 (Q4).

When the motor enters generation mode, the voltages V_{dc1} and V_{dc2} at capacitors 710 and 711 may begin to increase, which is detected by controller 220 using voltage sensors 310. If the voltages at capacitor 710 and/or capacitor 711 increase to a magnitude that exceeds a threshold voltage, controller 220 switches integrated L-based VB-BC circuit 708 from VB mode to BC mode, by modifying the operation of power switches 712 (Q1), 713 (Q2), 714 (Q3), and 715 (Q4) and turning chopper switch 718 and/or chopper switch 719 on (closed). During BC mode, brake resistors 716 and 717 dissipate the excess energy transferred from the motor to integrated L-based VB-BC circuit 708 as heat. During VB mode, power switches 713 (Q2) and 714 (Q3) are off, and power switches 712 (Q1) and 714 (Q4) switch together.

When controller 220 determines that generation mode has ended, controller 220 switches integrated L-based VB-BC circuit 708 from BC mode to VB mode, and controller 220 operates power switches 712 (Q1) and 713 (Q2) at the same time, and operates power switches 714 (Q3) and 714 (Q4) also at the same time, but complimentary to power switches 712 (Q1) and 713 (Q2).

As discussed above, when controller 220 operates power switches 712 (Q1), 713 (Q2), 714 (Q3), and 715 (Q4) while chopper switches 718 and 719 are off (open circuit), VB operation is implemented by integrated L-based VB-BC circuit 708. BC operation is implemented when controller 220 turns chopper switches 718 and 719 on (closed). In order to prevent the VB and BC operations from interfering with each other, controller 220 may turn on (close) chopper switches 718 and 719 during the dead time of power switches 712 (Q1), 713 (Q2), 714 (Q3), and 715 (Q4) when the current iᵣ of inductor 720 is about zero amps. Because adding brake resistors 716 and 717 in integrated L-based VB-BC circuit 708 does not modify the operation of the circuit, controller 220 may continue to operate power switches 713 (Q2) and 714 (Q3) during BC operation. However, they may not be needed for BC operation and their operation may generate additional losses. Therefore, power switches 713 (Q2) and 714 (Q3) may be turned off during BC operation.

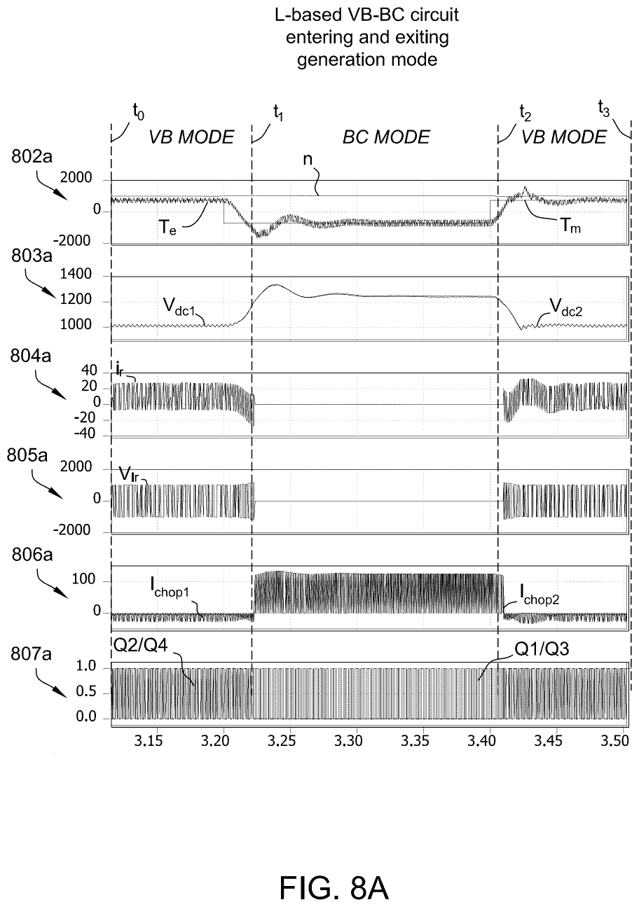

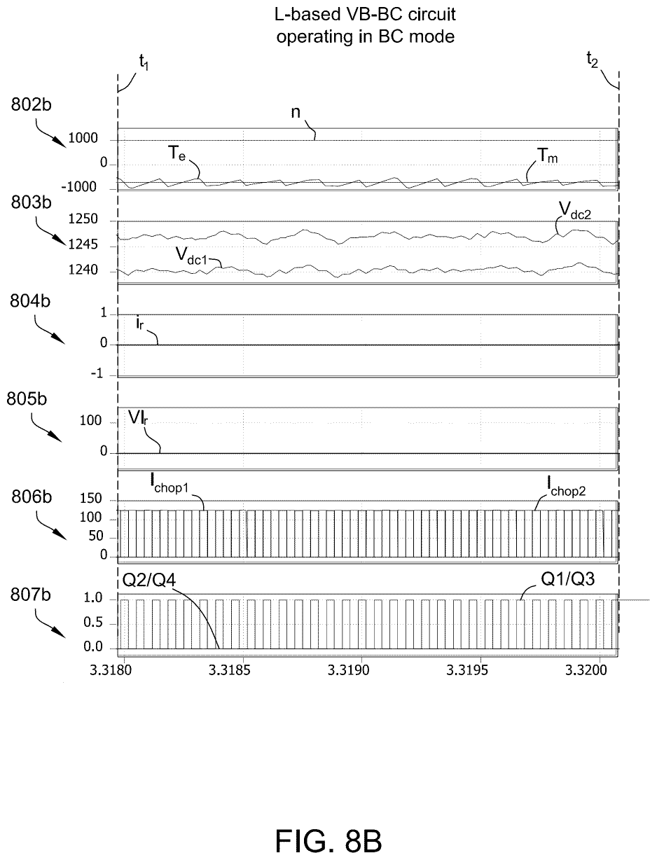

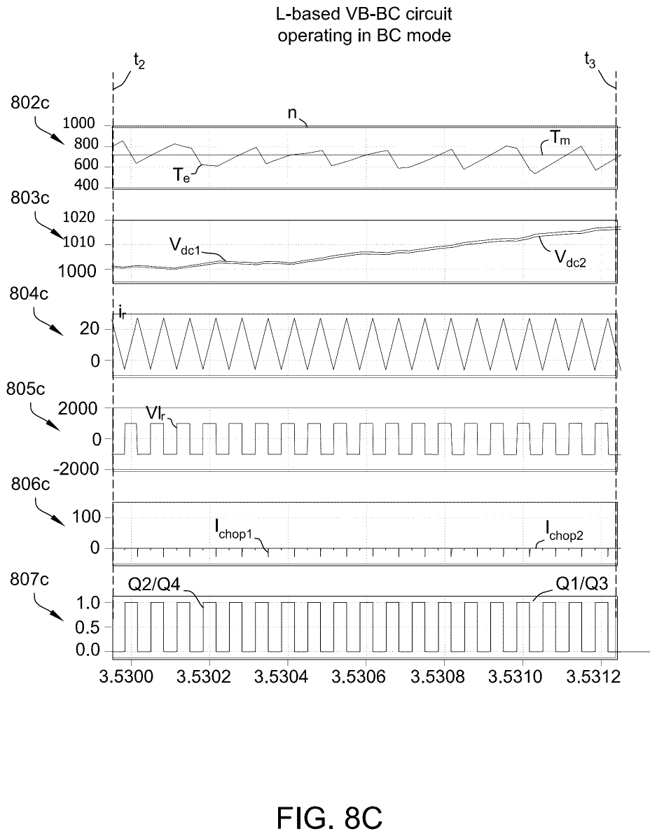

FIG. 8A depicts graphs 802a, 803a, 804a, 805a, 806a, and 807a that illustrate various electrical and operating states of integrated L-based VB-BC circuit 708 as the motor enters into and out of generation mode in an exemplary embodiment. FIG. 8B depicts graphs 802b, 803b, 804b, 805b, 806b, and 807b that illustrate various electrical and operating states of integrated L-based VB-BC circuit 708 during BC mode in an exemplary embodiment. FIG. 8C depicts graphs 802c, 803c, 804c, 805c, 806c, and 807c that illustrate various electrical and operating states of integrated L-based VB-BC circuit 708 during VB mode in an exemplary embodiment.

In particular, integrated L-based VB-BC circuit 708 operates in VB mode at time t0 and t3, enters into BC mode from VB mode at time tᵢ, and exits BC mode into VB mode at time t₂

Graphs 802a, 802b, and 802c illustrate the speed of the motor (n), the electrical torque Tₑ of the motor, and the motor loading torque Tₘ. Graphs 803a, 803b, and 803c illustrate the voltage V_{dc1} at capacitors 710 and the voltage V_{dc2} at capacitor 711. Graphs 804a, 804b, and 804c illustrate the current iᵣ of inductor 720. Graphs 805a, 805b, and 805c illustrate the voltage Viᵣ of inductor 720. Graphs 806a, 806b, and 806c illustrate the chopper current I_{chop1} and I_{chop2}, and graphs 807a, 807b, and 807c illustrate the control signals of power switches 712 (Q1), 713 (Q2), 714 (Q3), and 715 (Q4). From time t₀ to t₁, integrated L-based VB-BC circuit 708 starts by operating in VB mode, where controller 220 operates power switches 712 (Q1) and 713 (Q2) to switch at the same time and power switches 714 (Q3) and 715 (Q4) to also switch at the same time, but complimentary to power switches 712 (Q1) and 713 (Q2), in order to balance the voltage V_{dc1} at capacitor 710 and the voltage V_{dc2} at capacitor 711 with each other. When the voltages V_{dc1} and V_{dc2} of capacitors 710 and 711 increase to a magnitude that exceeds a threshold voltage due to the motor operating in generation mode (e.g., Tₑ is negative), controller 220 turns on (closes) chopper switches 718 and 719, deactivates power switches 713 (Q2) and 714 (Q3) and continues to operate power switches 712 (Q1) and 715 (Q4), and integrated L-based VB-BC circuit 708 operates in BC mode as depicted in FIG. 8B. Braking chopper currents I_{chop1} and I_{chop2} flowing through brake resistors 716 and 717, respectively, dissipate the energy supplied by the motor as heat. After integrated L-based VB-BC circuit 708 transitions out of BC mode (e.g., Tₑ transitions from negative to positive at time t₂), controller 220 transitions integrated L-based VB-BC circuit 708 from BC mode to VB mode, which is depicted in FIG. 8C. In VB mode, controller 220 operates power switches 712 (Q1) and 713 (Q2) to switch at the same time and power switches 714 (Q3) and 715 (Q4) to also switch at the same time, but complimentary to power switches 712 (Q1) and 713 (Q2), to balance the voltage V_{dc1} at capacitor 710 with the voltage V_{dc2} at capacitor 711.

Although the embodiments described herein have illustrated their use in dual stator AC motors, each of integrated LC-based VB-BC circuit 204, integrated C-based VB-BC circuit 508, and integrated L-based VB-BC circuit 708 are scalable and able to perform both VB and BC functions for an arbitrary number of DC link capacitors in series that supply inverter/winding sets. Two expansion approaches will be described below, a series expansion and a rainstick expansion, although each of each of integrated LC-based VB-BC circuit 204, integrated C-based VB-BC circuit 508, and integrated L-based VB-BC circuit 708 may be scaled using other techniques, not described.

A series expansion approach may have a lower number of active switches, but the switches should be synchronized. All top devices in a half-bridge may need to switch at the same time, and all the bottom devices in the half-bridge may need to switch at the same time, meanwhile being complementary with each other. The rainstick expansion approach may have a higher number of active switches, but they may not need to be synchronized between different rainstick modules.

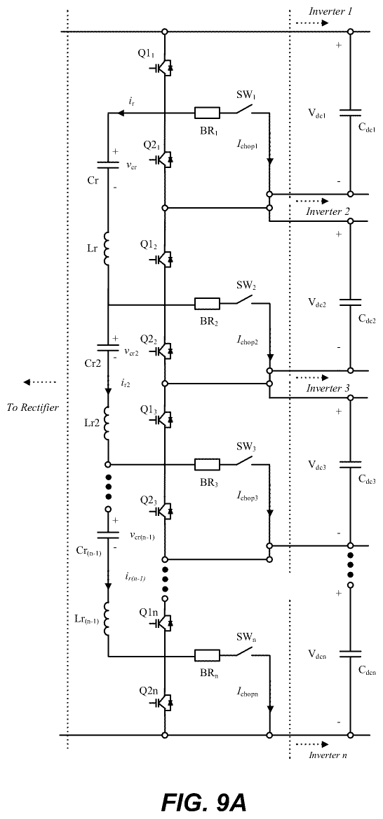

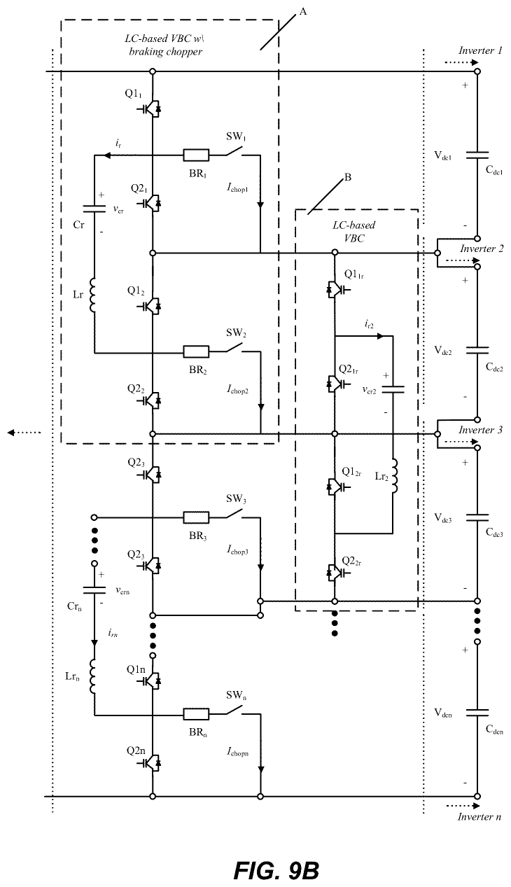

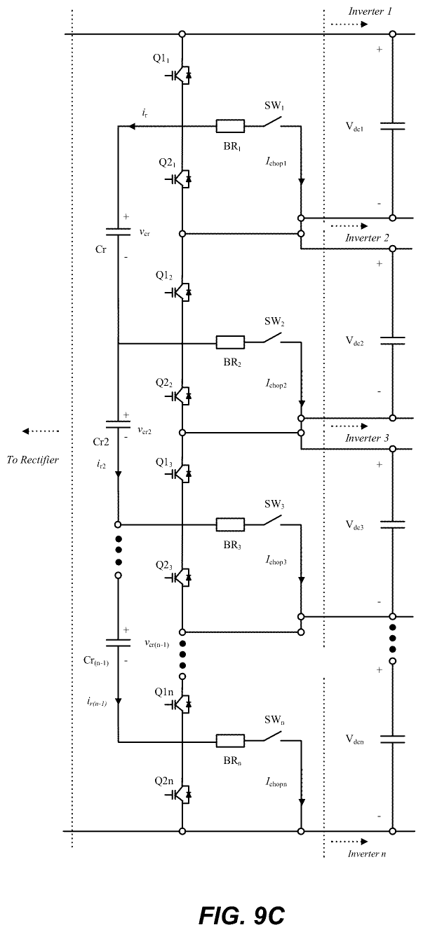

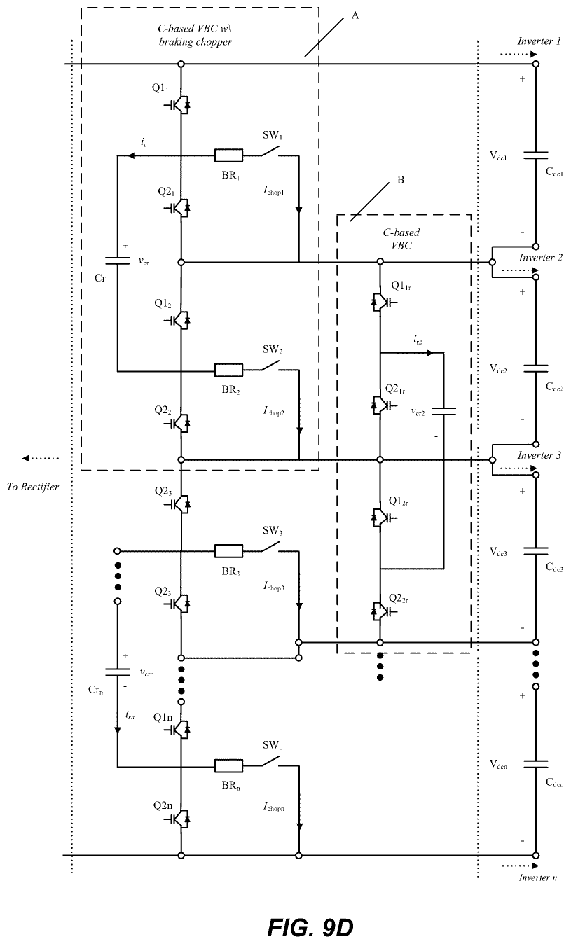

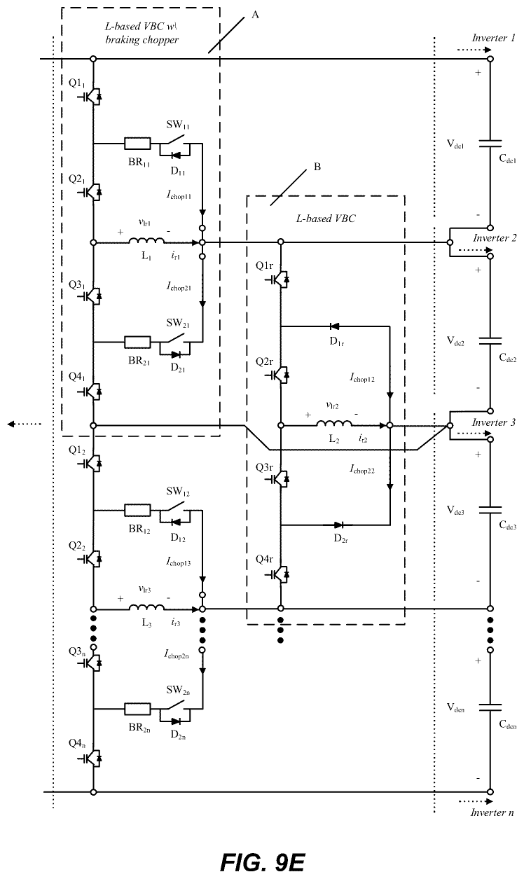

FIGS. 9A, 9B, 9C, 9D, and 9E depict various expansion circuit topologies for integrated LC-based VB-BC circuit 204, integrated C-based VB-BC circuit 508, and integrated L-based VB-BC circuit 708 in exemplary embodiments. FIG. 9A depicts a series approach for integrated LC-based VB-BC circuit 204 having (n-1) resonant tanks (L and C) and n chopper branches (BR and SW). FIG. 9B depicts a rainstick expansion approach for integrated LC-based VB-BC circuit 204 where instead of duplicating integrated LC-based VB-BC circuit 204, marked as “A”, in order to avoid duplication of chopper circuits, a VB portion of integrated LC-based VB-BC circuit 204 is utilized, marked as “B”. FIG. 9C depicts a series expansion circuit topology for integrated C-based VB-BC circuit 508, and FIG. 9D depicts a rainstick circuit topology for integrated C-based VB-BC circuit 508 where instead of duplicating integrated C-based VB-BC circuit 508, marked “A”, in order to avoid duplication of chopper circuits, a VB part of the integrated C-based VB-BC circuit 508 is utilized, marked as “B”. FIG. 9E depicts a rainstick expansion circuit topology for integrated L-based VB-BC circuit 708, as integrated L-based VB-BC circuit 708 may not expanded in a series manner. Instead of duplicating integrated L-based VB-BC circuit 708, marked “A”, in order to avoid duplication of chopper circuits, a VB part of L-based VB-BC circuit 708 is utilized, marked as “B”.

An example technical effect of the embodiments described herein includes one or more of: (a) reducing the number of components while maintaining the same functionality as discrete VB and BC implementations; (b) a lower number of components reduces the cost of the solution; (c) a lower number of components increases the reliability of the solution; and (d) the embodiments described herein are scalable for topologies having more than two main capacitors in series.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An integrated voltage balancing and braking chopper circuit, comprising:
first, second, third, and fourth power switches coupled in series to form a first branch, wherein the first branch is in parallel with a second branch comprising first and second capacitors coupled in series, and wherein the first and second capacitors have a first node disposed therebetween;
a first brake resistor coupled in series with a first chopper switch to form a third branch, wherein the third branch is coupled between a terminal of the first capacitor and a second node disposed between the first and second power switches, and wherein the second and third power switches have a third node disposed therebetween;
a second brake resistor coupled in series with a second chopper switch to form a fourth branch, wherein the fourth branch is coupled between a terminal of the second capacitor and a fourth node disposed between the third and fourth power switches; and
a third capacitor and/or an inductor forming a fifth branch, wherein the fifth branch is coupled between (i) the second node and the fourth node, or (ii) the first node and the third node.

2. The integrated voltage balancing and braking chopper circuit of claim 1, further comprising:
a controller configured to modify an operation of the first, second, third, and fourth power switches and the first and second chopper switches to (i) balance a first voltage of the first capacitor with a second voltage of the second capacitor utilizing the third capacitor and/or the inductor, and (ii) dissipate energy stored in the first and second capacitors utilizing the first and second brake resistors.

3. The integrated voltage balancing and braking chopper circuit of claim 2, wherein the controller is further configured to:
determine whether at least one of the first voltage and the second voltage is greater than a threshold voltage; and
close at least one of the first and second chopper switches to dissipate the energy stored in at least one of the first and second capacitors in response to determining that at least one of the first voltage and the second voltage is greater than the threshold voltage.

4. The integrated voltage balancing and braking chopper circuit of claim 3, wherein:
the fifth branch comprises the third capacitor coupled in series with the inductor,
the fifth branch is electrically coupled between the second node and the fourth node, and
the controller is further configured to turn off the second and fourth power switches while the first and second chopper switches are closed.

5. The integrated voltage balancing and braking chopper circuit of claim 3, wherein:
the fifth branch comprises only the inductor,
the inductor is coupled between the first node and the third node, and
the controller is further configured to turn off the second and third power switches while the first and second chopper switches are closed.

6. The integrated voltage balancing and braking chopper circuit of claim 3, wherein:
the fifth branch comprises only the third capacitor,
the third capacitor is coupled between the second node and the fourth node, and
the controller is further configured, while the first and second chopper switches are closed, to:
operate the second and fourth power switches together; and
operate the first and third power switches together and complementary to the second and fourth power switches.

7. The integrated voltage balancing and braking chopper circuit of claim 1, wherein:
the fifth branch comprises the third capacitor coupled in series with the inductor, and
the fifth branch is electrically coupled between the second node and the fourth node.

8. The integrated voltage balancing and braking chopper circuit of claim 1, wherein:
the fifth branch comprises only the third capacitor, and
the third capacitor is coupled between the second node and the fourth node.

9. The integrated voltage balancing and braking chopper circuit of claim 1, wherein:
the fifth branch comprises only the inductor, and
the inductor is coupled between the first node and the third node.

10. The integrated voltage balancing and braking chopper circuit of claim 9, wherein:
the third branch is coupled between the second node and a negative terminal of the first capacitor, and
the fourth branch is coupled between the fourth node and a positive terminal of the second capacitor.

11. The integrated voltage balancing and braking chopper circuit of claim 1, wherein:
the third branch is coupled between the second node and a negative terminal of the first capacitor, and
the fourth branch is coupled between the fourth node and a negative terminal of the second capacitor.

12. The integrated voltage balancing and braking chopper circuit of claim 1, wherein:
at least one of the first chopper switch and the second chopper switch comprises a mechanical switch.

13. A drive system for an alternating current (AC) multiphase machine, the drive system comprising
a first inverter comprising a first capacitor;
a second inverter comprising a second capacitor, wherein the first and second capacitors are coupled in series to form a first branch, and wherein the first and second capacitors have a first node disposed therebetween; and
an integrated voltage balancing and braking chopper circuit, comprising:
first, second, third, and fourth power switches coupled in series to form a second branch, wherein the second branch is in parallel with the first branch;
a first brake resistor coupled in series with a first chopper switch to form a third branch, wherein the third branch is coupled between a terminal of the first capacitor and a second node disposed between the first and second power switches, and wherein the third and fourth power switches have a third node disposed therebetween;
a second brake resistor coupled in series with a second chopper switch to form a fourth branch, wherein the fourth branch is coupled between a terminal of the second capacitor and a fourth node disposed between the third and fourth power switches; and
a third capacitor and/or an inductor forming a fifth branch, wherein the fifth branch is coupled between (i) the second node and the fourth node, or (ii) the first node and the third node.

14. The drive system of claim 13, further comprising:
a controller configured to modify an operation of the first, second, third, and fourth power switches and the first and second chopper switches to (i) balance a first voltage of the first capacitor with a second voltage of the second capacitor utilizing the third capacitor and/or the inductor, and (ii) dissipate energy stored in the first and second capacitors utilizing the first and second brake resistors.

15. The drive system of claim 14, wherein the controller is further configured to:
determine whether at least one of the first voltage and the second voltage is greater than a threshold voltage; and
close at least one of the first and second chopper switches to dissipate the energy stored in at least one of the first and second capacitors in response to determining that at least one of the first voltage and the second voltage is greater than the threshold voltage.

16. The drive system of claim 15, wherein:
the fifth branch comprises the third capacitor in series with the inductor,
the fifth branch is coupled between the second node and the fourth node, and
the controller is further configured to turn off the second and fourth power switches while the first and second chopper switches are closed.

17. The drive system of claim 15, wherein:
the fifth branch comprises only the inductor,
the inductor is coupled between the first node and the third node, and
the controller is further configured to turn off the second and third power switches while the first and second chopper switches are closed.

18. The drive system of claim 15, wherein:
the fifth branch comprises only the third capacitor,
the third capacitor is coupled between the second node and the fourth node, and
the controller is further configured, while the first and second chopper switches are closed, to:
operate the second and fourth power switches together; and
operate the first and third power switches together and complementary to the second and fourth power switches.

19. The drive system of claim 14, wherein:
at least one of the first chopper switch and the second chopper switch comprises a mechanical switch.

20. An integrated voltage balancing and braking chopper circuit, comprising:
a first power switch coupled between a positive terminal of a first capacitor and a first node;
a second power switch coupled between the first node and a second node;
a third power switch coupled between the second node and a third node;
a fourth power switch coupled between the third node and a negative terminal of a second capacitor, wherein the first and second capacitors are coupled in series;
a first breaking chopper coupled between the first node and one of the positive terminal of the first capacitor and a negative terminal of the first capacitor;
a second breaking chopper coupled between the third node and one of a positive terminal of the second capacitor and the negative terminal of the second capacitor; and
a third capacitor and/or an inductor coupled between (i) the first node and the third node, or (ii) the second node and a fourth node at a connection between the negative terminal of the first capacitor and the positive terminal of the second capacitor.
